(19) United States
(12) Patent Application Publication
(10) Pub. No.: US 2008/0214160 A1
(43) Pub. Date: Sep. 4, 2008

(54) MOTION-CONTROLLED AUDIO OUTPUT

(75) Inventor: Marten Andreas JONSSON, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/680,879

(22) Filed: Mar. 1, 2007

(51) Int. Cl. H04M 3/42

(52) U.S. Cl. 455/414.2

(57) ABSTRACT

A motion of a mobile device, such as motions detected with an accelerometer, may be used to trigger an audio manipulation effect. In one implementation, logic is configured to output audio. Second logic is configured to identify a movement of the mobile device and third logic is configured to manipulate the output audio based on the identified movement.

### TECHNICAL FIELD OF THE INVENTION

The invention relates generally to the operation of mobile communication devices and, more particularly, to controlling audio output from mobile communication

### DESCRIPTION OF RELATED ART

Mobile communication devices and other electronic device, such as cellular telephones and personal media players have become increasingly versatile. Typically, mobile electronic devices include audio output mechanisms, such as speakers or headphone jacks, for outputting sound or audio in response to commands or actions performed on the device.

### SUMMARY

According to one aspect, a mobile device includes first logic configured to output audio. The mobile device also includes second logic configured to identify a movement of the mobile device and third logic configured to manipulate the output audio based on the identified movement.

Additionally, the first logic may be configured to output audio in response to an executed command.

Additionally, the mobile device may include a mobile communications device.

Additionally, the executed command may include a ring tone playback command generated in response to a received call.

Additionally, the executed command may include a message alert playback command generated in response to a received message.

Additionally, the mobile device may include a portable media player.

Additionally, the executed command may include a media playback command received by the portable media player.

Additionally, the second logic may include a motion sensing component.

Additionally, the motion sensing component may include an accelerometer.

Additionally, the second logic may include logic configured to determine whether a movement of the mobile device matches a stored movement, where the stored movement is associated with a predetermined manipulation effect.

Additionally, the third logic may include logic configured to manipulate the output audio based on the predetermined manipulation effect.

Additionally, the predetermined manipulation effect may include a modification of the output audio.

Additionally, the predetermined manipulation effect may include a sound effect not associated with the output audio.

Additionally, the predetermined manipulation effect may include a sound command for adjusting properties of the output audio.

Another aspect is directed to a method implemented in a mobile terminal. The method may include executing a command to output audio; monitoring movement of the mobile terminal; and manipulating the output audio based on the movement

Additionally, monitoring movement of the mobile terminal may include analyzing an output of a motion sensing component; and determining whether the output of the motion sensing component a motion associated with a previously stored audio output manipulation effect.

Additionally, manipulating the output audio based on the movement may include manipulating the output audio based on the previously stored audio output manipulation effect.

Additionally, the motion sensing component may include an accelerometer.

Another aspect is directed to a portable media device. The portable media device may include means for outputting audio; means for identifying a movement of the portable media device; and means for adjusting the output audio based on the identified movement.

Additionally, the portable media device may include means for generating a signal representative of the movement of the portable media device; means for determining whether the signal matches a stored signal associated with an audio adjustment command; and means for adjusting the output audio based on the audio adjustment command.

Additionally, the means for generating a signal representative of the movement of the portable media device may include an accelerometer

Other features and advantages of the invention will become readily apparent to those skilled in this art from the following detailed description. The embodiments shown and described provide illustration of the best mode contemplated for carrying out the invention. The invention is capable of modifications in various obvious respects, all without departing from the invention. Accordingly, the drawings are to be regarded as illustrative in nature, and not as restrictive.

### BRIEF DESCRIPTION OF THE DRAWINGS

Reference is made to the attached drawings, wherein elements having the same reference number designation may represent like elements throughout.

FIG. 1 is a diagram of an exemplary electronic device;

FIG. 2 is a diagram illustrating additional details of the mobile terminal shown in FIG. 1;

FIG. 3 is a flow chart illustrating exemplary operations of the mobile terminal of FIG. 2 in receiving audio output manipulation commands based on perceived motion of the mobile terminal; and

FIGS. 4-6 are diagrams illustrating exemplary motions of the mobile terminal resulting in execution of associated audio manipulation effects.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims and equivalents.

### Exemplary Electronic Device

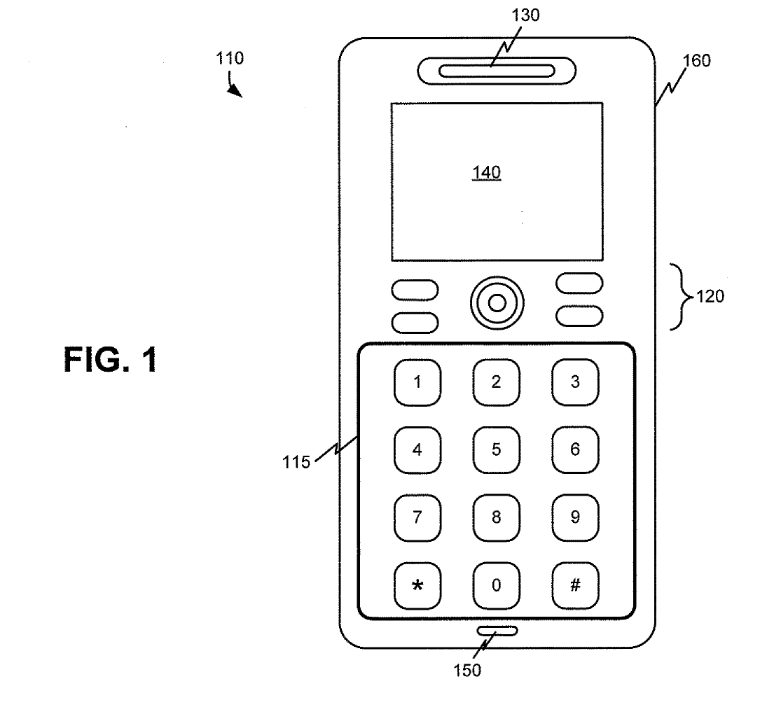

FIG. 1 is a diagram of an exemplary implementation of a device consistent with the invention. The device can be any type of portable electronic device. The device will particularly be described herein as a mobile terminal 110 that may include a radiotelephone or a personal communications system (PCS) terminal that may combine a cellular radiotelephone with data processing, a facsimile, and/or data communications capabilities. It should be understood that the various aspects described herein may be implemented in a variety of electronic devices, such as portable media players, personal digital assistants (PDAs), smartphones, etc.

Mobile terminal 110 may include housing 160, keypad 115, control keys 120, speaker 130, display 140, and microphone 150. Housing 160 may include a structure configured to hold devices and components used in mobile terminal 110. For example, housing 160 may be formed from plastic, metal, or composite and may be configured to support keypad 115, control keys 120, speaker 130, display 140 and microphone 150.

Keypad 115 may include devices and/or logic that can be used to operate mobile terminal 110. Keypad 115 may further be adapted to receive user inputs, directly or via other devices, such as via a stylus for entering information into mobile terminal 110. In one implementation, communication functions of mobile terminal 110 may be controlled by activating keys in keypad 115. The keys may have key information associated therewith, such as numbers, letters, symbols, etc. The user may operate keys in keypad 115 to place calls, enter digits, commands, and text messages, into mobile terminal 110. Designated functions of keys may form and/or manipulate images that may be displayed on display 140.

Control keys 120 may include buttons that permit a user to interact with communication device 110 to cause communication device 110 to perform specified actions, such as to interact with display 140, etc.

Speaker 130 may include a device that provides audible information to a user of mobile terminal 110. Speaker 130 may be located anywhere on mobile terminal 110 and may function, for example, as an earpiece when a user communicates using mobile terminal 110. Speaker 130 may include several speaker elements provided at various locations within mobile terminal 110. Speaker 130 may also include a digital to analog converter to convert digital signals into analog signals. Speaker 130 may also function as an output device for a ringing signal indicating that an incoming call is being received by communication device 110. As will be described in additional detail below, audio output from speaker 130 may be manipulated by manipulating mobile terminal 110.

Display 140 may include a device that provides visual images to a user. For example, display 140 may provide graphic information regarding incoming/outgoing calls, text messages, games, phonebooks, the current date/time, volume settings, etc., to a user of mobile terminal 110. Implementations of display 140 may be implemented as black and white or color flat panel displays.

Microphone 150 may include a device that converts speech or other acoustic signals into electrical signals for use by mobile terminal 110. Microphone 150 may also include an analog to digital converter to convert input analog signals into digital signals. Microphone 150 may be located anywhere on mobile terminal 110 and may be configured, for example, to convert spoken words or phrases into electrical signals for use by mobile terminal 110.

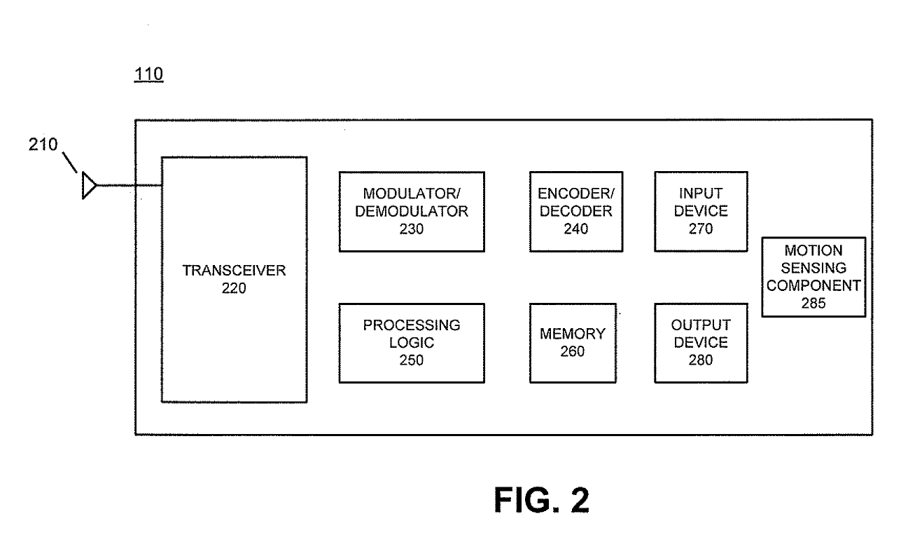

FIG. 2 is a diagram illustrating additional exemplary details of mobile terminal 110. Mobile terminal 110 may include a radio frequency (RF) antenna 210, transceiver 220, modulator/demodulator 230, encoder/decoder 240, processing logic 250, memory 260, input device 270, output device 280, and motion sensing component 285. These components may be connected via one or more buses (not shown). In addition, mobile terminal 110 may include one or more power supplies (not shown). One skilled in the art would recognize that the mobile terminal 110 may be configured in a number of other ways and may include other or different elements.

RF antenna 210 may include one or more antennas capable of transmitting and receiving RF signals. In one implementation, RF antenna 210 may include one or more directional and/or omni-directional antennas. Transceiver 220 may include components for transmitting and receiving information via RF antenna 210. In an alternative implementation, transceiver 220 may take the form of separate transmitter and receiver components, instead of being implemented as a single component.

Modulator/demodulator 230 may include components that combine data signals with carrier signals and extract data signals from carrier signals. Modulator/demodulator 230 may include components that convert analog signals to digital signals, and vice versa, for communicating with other devices in mobile terminal 110.

Encoder/decoder 240 may include circuitry for encoding a digital input to be transmitted and for decoding a received encoded input. Processing logic 250 may include a processor, microprocessor, an application specific integrated circuit (ASIC), field programmable gate array (FPGA) or the like. Processing logic 250 may execute software programs or data structures to control operation of mobile terminal 110. Memory 260 may include a random access memory (RAM) or another type of dynamic storage device that stores information and instructions for execution by processing logic 250; a read only memory (ROM) or another type of static storage device that stores static information and instructions for use by processing logic 250; and/or some other type of magnetic or optical recording medium and its corresponding drive. Instructions used by processing logic 250 may also, or alternatively, be stored in another type of computer-readable medium accessible by processing logic 250. A computer-readable medium may include one or more memory devices.

Input device 270 may include any mechanism that permits an operator to input information to mobile terminal 110, such as microphone 150 or keypad 115. Output device 280 may include any mechanism that outputs information to the operator, including display 140 or speaker 130. Output device 280 may also include a vibrator mechanism that causes mobile terminal 110 to vibrate.

Motion sensing component 285 may provide an additional input mechanism for input device 270. Motion sensing component 285 may be generally used to sense user input to mobile terminal 110 based on movement of mobile terminal 110. In one implementation, motion sensing component 285 may include one or more accelerometers for sensing movement of mobile terminal 110 in one or more directions (e.g., one, two, or three directional axes). The accelerometer may output signals to input device 270. Alternatively (on in conjunction with an accelerometer), motion sensing component 285 may include one or more gyroscopes for sensing and identifying a position of mobile terminal 110. Motion sensing component 285 such as accelerometers and gyroscopes are generally known in the art and additional details relating to the operation of motion sensing component 285 will not be described further herein.

Mobile terminal 110 may perform processing associated with, for example, operation of the core features of mobile terminal 110 or operation of additional applications associated with mobile terminal 110, such as software applications provided by third party software providers. Mobile terminal 110 may perform these operations in response to processing logic 250 executing sequences of instructions contained in a computer-readable medium, such as memory 260. It should be understood that a computer-readable medium may include one or more memory devices and/or carrier waves. Execution of sequences of instructions contained in memory 260 causes processing logic 250 to perform acts that will be described hereafter. In alternative embodiments, hard-wired circuitry may be used in place of or in combination with software instructions to implement processes consistent with the invention. Thus, implementations consistent with the invention are not limited to any specific combination of hardware circuitry and software.

### Exemplary Processing

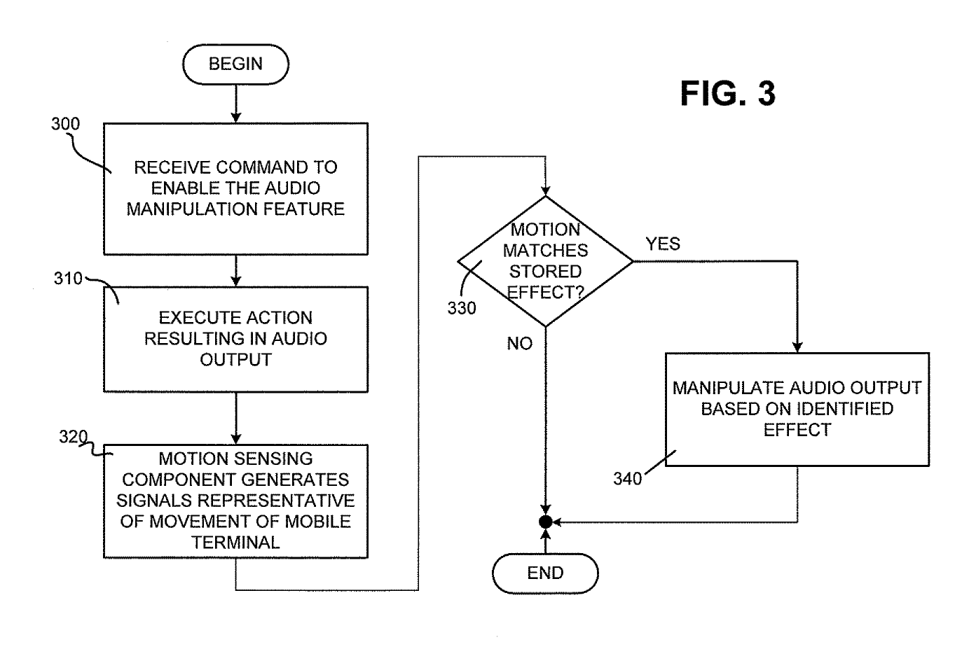

FIG. 3 is a flow chart illustrating exemplary operations of mobile terminal 110 in receiving audio output manipulation commands based on perceived motion of mobile terminal 110. Processing may begin with mobile terminal 110 receiving a command to enable the audio output manipulation feature (block 300).

Mobile terminal 110 may execute an action resulting in output of audio via speaker 130 (block 310). For example, mobile terminal 110 may receive a telephone call or message via transceiver 220 resulting in output of an audible ring tone or alert via speaker 130. Alternatively, mobile terminal 110 may receive a user request to playback or otherwise output an audio file stored in memory 260.

Simultaneously with the audio output via speaker 130, motion sensing component 285 may generate one or more output signals representative of a motion of mobile terminal 110 (block 320). The motion sensing component output signals may be analyzed to determine whether the motion of mobile terminal 110 matches a motion associated with a previously stored audio output manipulation effect (block 330). If so, mobile terminal 110 may manipulate the output of speaker 130 in a manner consistent with the identified manipulation effect (block 340). Manipulation effects may include any suitable modification and alteration of the audio output resulting from the executed action. Additionally, exemplary manipulation effects may include the output of additional sound effects or sound commands unassociated with the audio output resulting from the executed action, such as a breaking glass effect, an explosion effect, etc. Exemplary sound commands may include volume adjustments, track pausing or skipping commands, etc.

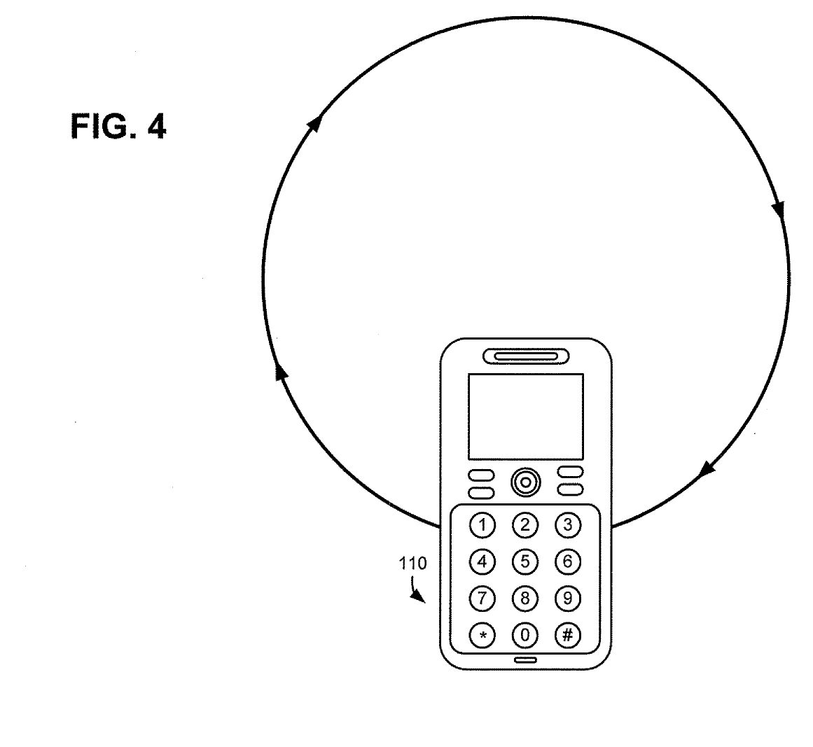

In one exemplary implementation, it may be determined that mobile terminal is being moved in a circular motion (see, for example, FIG. 4). If an audio manipulation effect has been previously associated with a circular motion, audio output via speaker 130 may be manipulated in a manner consistent with the stored effect. For example, moving mobile terminal 110 in the motion shown in FIG. 4 may cause the audio output to be phase-modulated.

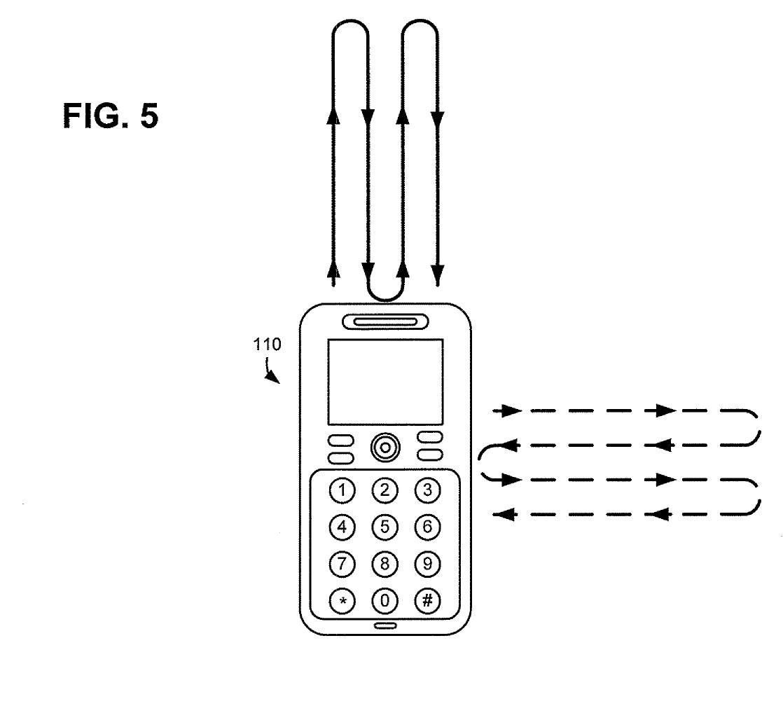

In an additional exemplary embodiment, it may be determined that mobile terminal is being moved in a rapid back and forth manner, such as that depicted in FIG. 5. Such an identified motion may cause the audio output to be “scratched” or distorted as if a phonograph needle were being moved rapidly along grooves in a phonograph album.

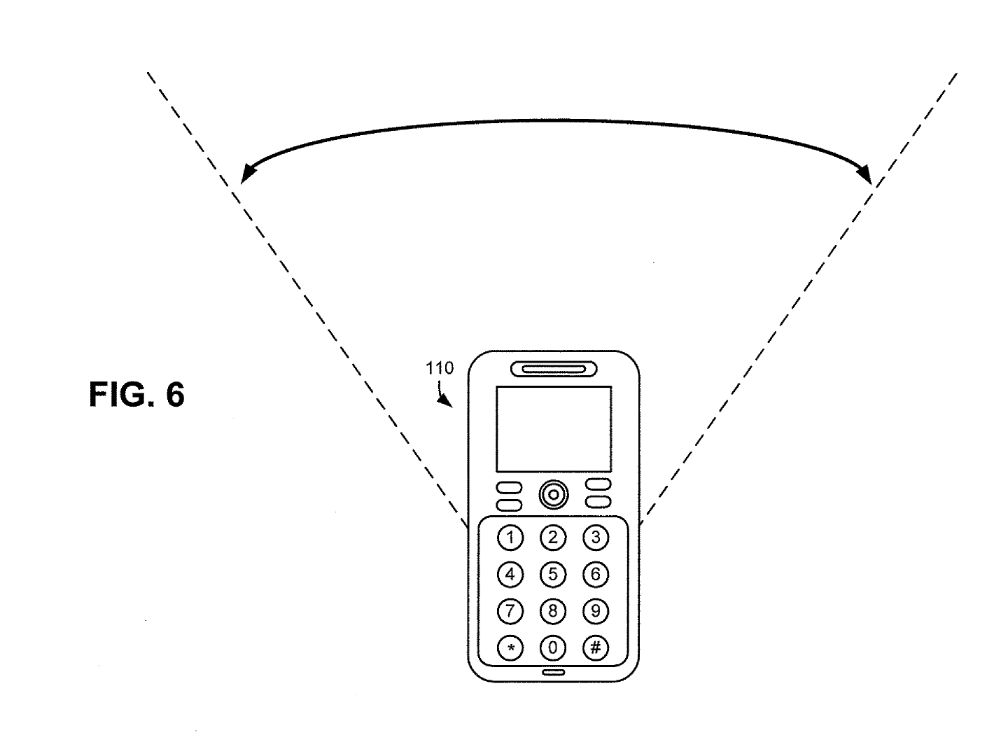

In still another exemplary embodiment, it may be determined that mobile terminal is being moved in a swinging side to side motion, such as that depicted in FIG. 6. In this embodiment, recognition of this movement during audio output may cause the audio output to be manipulated in a manner similar to a light saber sound effect similar to that used in the StarWars® family of motion pictures.

Techniques for analyzing acceleration signals from an accelerometer and matching the signals to predetermined “goal” signals are known in the art and will therefore not be described further herein

In some implementations, the possible set of motions that are recognized by mobile terminal 110 as well as the manipulation effects associated with the motions may be customizable by the user. In other words, the user may have a particular arbitrary motion that he would like to associate with a particular audio output manipulation effect. For example, the user may wish to associate quickly moving mobile terminal to the left with a command to silence the audio output. The user may begin by “demonstrating” (performing) the motion one or more times. The user may then direct mobile terminal 110 to associate the newly trained motion with a particular audio output manipulation effect.

### CONCLUSION

As described above, motion of a mobile terminal may be used to trigger manipulation of an output audio based on a manipulation effect associated with the motion.

The foregoing description of the embodiments of the invention provides illustration and description, but is not intended to be exhaustive or to limit the invention to the precise form disclosed. Modifications and variations re possible in light of the above teachings or may be acquired from practice of the invention.

Further, while a series of acts has been described with respect to FIG. 3, the order of the acts may be varied in other implementations consistent with the invention. Moreover, non-dependent acts may be performed in parallel.

It will also be apparent to one of ordinary skill in the art that aspects of the invention, as described above, may be implemented in cellular communication devices/systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

The scope of the invention is defined by the claims and their equivalents.

What is claimed is:

1. A mobile device comprising:
first logic configured to output audio;
second logic configured to identify a movement of the mobile device; and
third logic configured to manipulate the output audio based on the identified movement.

2. The mobile device of claim 1, wherein the first logic is configured to output audio in response to an executed command.

3. The mobile device of claim 2, wherein the mobile device comprises a mobile communications device.

4. The mobile device of claim 3, wherein the executed command comprises a ring tone playback command generated in response to a received call.

5. The mobile device of claim 3, wherein the executed command comprises a message alert playback command generated in response to a received message.

6. The mobile device of claim 2, wherein the mobile device comprises a portable media player.

7. The mobile device of claim 6, wherein the executed command comprises a media playback command received by the portable media player.

8. The mobile device of claim 1, wherein the second logic comprises a motion sensing component.

9. The mobile device of claim 8, wherein the motion sensing component includes an accelerometer.

10. The mobile device of claim 1, wherein the second logic includes logic configured to determine whether a movement of the mobile device matches a stored movement, wherein the stored movement is associated with a predetermined manipulation effect.

11. The mobile device of claim 10, wherein the third logic includes logic configured to manipulate the output audio based on the predetermined manipulation effect.

12. The mobile device of claim 1, wherein the predetermined manipulation effect includes a modification of the output audio.

13. The mobile device of claim 1, wherein the predetermined manipulation effect includes a sound effect not associated with the output audio.

14. The mobile device of claim 1, wherein the predetermined manipulation effect includes a sound command for adjusting properties of the output audio.

15. A method implemented in a mobile terminal comprising:
executing a command to output audio;
monitoring movement of the mobile terminal; and
manipulating the output audio based on the movement.

16. The method of claim 15, wherein monitoring movement of the mobile terminal further comprises:
analyzing an output of a motion sensing component; and
determining whether the output of the motion sensing component a motion associated with a previously stored audio output manipulation effect.

17. The method of claim 16, wherein manipulating the output audio based on the movement further comprises:
manipulating the output audio based on the previously stored audio output manipulation effect.

18. The method of claim 16, wherein the motion sensing component includes an accelerometer.

19. A portable media device, comprising:
means for outputting audio;
means for identifying a movement of the portable media device; and
means for adjusting the output audio based on the identified movement.

20. The portable media device, further comprising:
means for generating a signal representative of the movement of the portable media device;
means for determining whether the signal matches a stored signal associated with an audio adjustment command; and
means for adjusting the output audio based on the audio adjustment command.

21. The portable media device, wherein the means for generating a signal representative of the movement of the portable media device comprises an accelerometer.
